(19) United States
(12) Patent Application Publication
(10) Pub. No.: US 2023/0318071 A1
(43) Pub. Date: Oct. 5, 2023

(54) SECONDARY BATTERY AND BATTERY MODULE

(71) Applicant: HONDA MOTOR CO., LTD., Tokyo (JP)

(72) Inventor: Hidemasa Usui, Wako-shi (JP)

(73) Assignee: HONDA MOTOR CO., LTD., Tokyo (JP)

(21) Appl. No.: 18/112,922

(22) Filed: Feb. 22, 2023

(30) Foreign Application Priority Data
Mar. 31, 2022 (JP) 2022-060746

(51) Int. Cl. H01M 10/615; H01M 10/655; H01M 10/647; H01M 10/613; H01M 50/105

(52) U.S. Cl. CPC H01M 10/647; H01M 10/613; H01M 10/615; H01M 10/655; H01M 50/105

(57) ABSTRACT

There is provided with a secondary battery having improved cooling and heating efficiency. The secondary battery comprises a laminate in which a positive electrode layer, an electrolyte layer, and a negative electrode layer are stacked, and an exterior body wrapping the laminate, the exterior body is formed by folding back one material for forming the exterior body at a folding back portion, the exterior body includes a housing portion which includes the folding back portion as a part thereof, and houses the laminate, and a peripheral edge portion around the housing portion, the peripheral edge portion includes a folding portion folded along the housing portion, and in the folding portion, the materials are not bonded to each other on a bent portion, and the materials are bonded to each other at portions other than the bent portion.

### CROSS-REFERENCE TO RELATED APPLICATION(S)

This application claims priority to and the benefit of Japanese Patent Application No. 2022-060746 filed on Mar. 31, 2022, the entire disclosure of which is incorporated herein by reference.

### BACKGROUND OF THE INVENTION

### Field of the Invention

The present invention relates to a secondary battery and a battery module.

### Description of the Related Art

In order to reduce CO₂ from the viewpoint of climate-related disasters, electrification of industrial machines has been promoted, and research on secondary batteries has also been conducted for applications such as vehicles as energy sources thereof. In a secondary battery group (battery module) including such a secondary battery (battery), since the performance, life, or the like of the battery may be affected by temperature, a structure for adjusting the temperature of the battery may be provided. Japanese Patent Laid-Open No. 2015-225765 describes a battery module including a thermally conductive material integrally in contact with a battery and a cooling plate.

In cooling and heating of the battery, it may be necessary to efficiently transfer heat of the battery or heat to the battery. However, depending on a degree of contact between the battery, the thermally conductive material, and the like, cooling and heating efficiency may decrease, and there is room for improvement in a cooling and heating structure.

### SUMMARY OF THE INVENTION

One embodiment of the present invention provides a secondary battery having improved cooling and heating efficiency. Furthermore, one embodiment contributes to energy efficiency.

According to one embodiment of the present invention, a secondary battery comprises: a laminate in which a positive electrode layer, an electrolyte layer, and a negative electrode layer are stacked; and an exterior body wrapping the laminate, wherein the exterior body is formed by folding back one material for forming the exterior body at a folding back portion, the exterior body includes a housing portion which includes the folding back portion as a part thereof, and houses the laminate, and a peripheral edge portion around the housing portion, the peripheral edge portion includes a folding portion folded along the housing portion, and in the folding portion, the materials are not bonded to each other on a bent portion, and the materials are bonded to each other at portions other than the bent portion.

According to one embodiment of the present invention, a secondary battery comprises: a laminate in which a positive electrode layer, an electrolyte layer, and a negative electrode layer are stacked; and an exterior body wrapping the laminate, wherein the exterior body is formed by overlapping two materials for forming the exterior body, and includes a housing portion which houses the laminate, and a peripheral edge portion around the housing portion, the peripheral edge portion includes a folding portion folded along the housing portion, in the folding portion, the materials are not bonded to each other on a bent portion, and the materials are bonded to each other at portions other than the bent portion.

### BRIEF DESCRIPTION OF THE DRAWINGS

FIG. 1 is a cross-sectional view schematically illustrating a battery module according to one embodiment;

FIG. 2 is a front view of a secondary battery according to one embodiment;

FIG. 3 is a cross-sectional view of the secondary battery according to one embodiment taken along line A-A;

FIG. 4 is a plan view illustrating a configuration of a material for forming an exterior body according to one embodiment;

FIG. 5 is a view taken in the direction of arrow C in FIG. 4;

FIG. 6 is a schematic view in which materials forming the exterior body according to one embodiment are overlapped with each other;

FIG. 7 is a front view of the secondary battery according to one embodiment, and is a view illustrating a state before an upper portion and a lower portion of the exterior body sealed are folded;

FIG. 8 is a cross-sectional view taken along line B-B in FIG. 2, and is a view illustrating a bent structure of the exterior body according to one embodiment;

FIG. 9 is a front view of a secondary battery according to another embodiment, and is a view illustrating a state before an upper portion and a lower portion of a sealed exterior body are folded;

FIG. 10 is a view illustrating a bent structure of an exterior body according to another embodiment;

FIG. 11 is a view illustrating a bent structure of an exterior body according to still another embodiment;

FIG. 12 is a plan view illustrating a configuration of a material for forming the exterior body according to another embodiment,

FIG. 13 is a view taken in the direction of arrow C in FIG. 12;

FIG. 14 is a view in which the material for forming the exterior body according to another embodiment is folded; and

FIG. 15 is a front view of the secondary battery according to another embodiment, and is a view illustrating a state before the upper portion of the sealed exterior body is folded.

### DESCRIPTION OF THE EMBODIMENTS

Hereinafter, embodiments will be described in detail with reference to the attached drawings. Note that the following embodiments are not intended to limit the scope of the claimed invention, and limitation is not made an invention that requires all combinations of features described in the embodiments. Two or more of the multiple features described in the embodiments may be combined as appropriate. Furthermore, the same reference numerals are given to the same or similar configurations, and redundant description thereof is omitted.

### Secondary Battery According to One Embodiment

A secondary battery according to one embodiment includes a laminate in which a positive electrode layer, an electrolyte layer, and a negative electrode layer are stacked, and an exterior body wrapping the laminate, in which the exterior body is formed by overlapping two materials for forming the exterior body, and includes a housing portion housing the laminate, and a peripheral edge portion around the housing portion. In addition, the peripheral edge portion includes a folding portion folded along the housing portion, the materials are not bonded to each other on a bent portion where the folding portion is bent, and the materials are bonded to each other at portions other than the bent portion. As a result, cooling and heating efficiency of the secondary battery can be improved. First, a battery module BM including the secondary battery according to one embodiment will be described, and details of the secondary battery will be described later.

### (Battery Module BM)

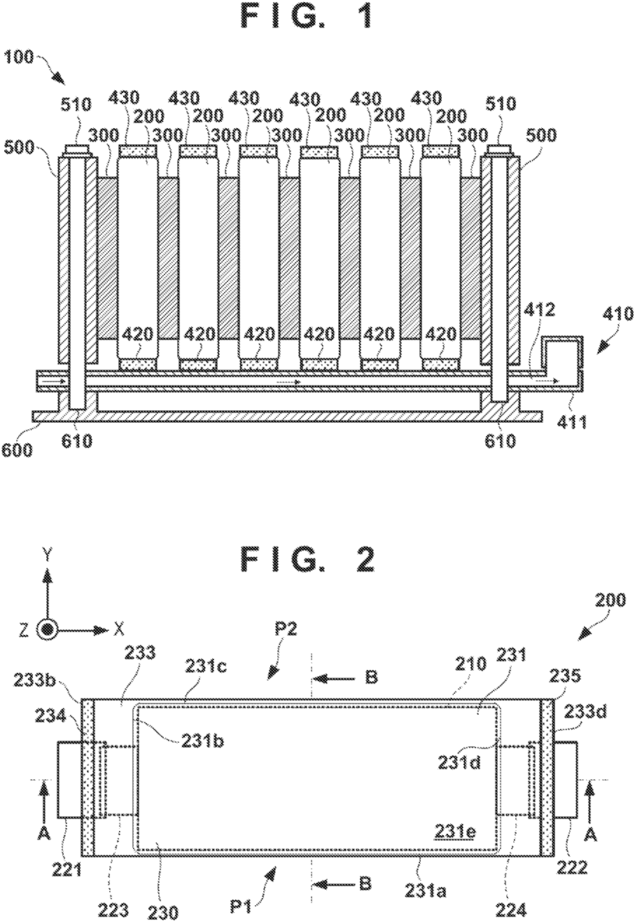

FIG. 1 is a cross-sectional view schematically illustrating the battery module according to one embodiment. A battery module 100 can be mounted on, for example, an electric vehicle such as a hybrid car or an EV (not illustrated). The battery module 100 includes a plurality of secondary batteries 200, a plurality of separators 300, a cooling and heating unit410, and a plurality of first heat transfer members 420. Furthermore, the battery module 100 can also include a plurality of second heat transfer members 430.

The plurality of secondary batteries (batteries) 200 are stacked in the thickness direction (Z direction) to constitute a secondary battery group. The secondary batteries 200 are alternately stacked in the Z direction with the separators 300 having insulating properties while being arranged in a standing posture. End plates 500 having a substantially flat plate shape are arranged at both ends in a stacking direction of a stacked product of the secondary battery 200 and the separator 300. A hole through which a fastening bolt 510 for fixing the battery module 100 to an installation site 600 can penetrate is formed in the end plate 500. The installation site 600 is formed with, for example, a pair of female screw portions 610 which is formed of a sheet metal of an electric vehicle and into which a pair of the fastening bolts 510 is screwed.

The cooling and heating unit 410 cools or heats the secondary battery 200. In the present embodiment, the cooling and heating unit 410 is a heat sink through which a refrigerant or a heat medium passes through a fluid passage 412 formed in a plate-shaped member 411. However, the cooling and heating unit 410 may have, for example, an air-cooling type cooling structure that introduces traveling wind during traveling of a vehicle, or other known techniques can be appropriately used.

### (First Heat Transfer Member)

The first heat transfer member 420 moves the heat of the secondary battery 200 or the heat to the secondary battery 200 to the cooling and heating unit 410 or from the cooling and heating unit 410. The first heat transfer member 420 is disposed between the secondary battery 200 and the cooling and heating unit 410. As the first heat transfer member 420, a thermally conductive gel such as a silicone gel may be used. Furthermore, for example, as the first heat transfer member 420, a urethane-based, epoxy-based, modified silane-based, or acryl-based heat dissipation adhesive, a silicone putty sheet for heat dissipation that is clayey and closely adheres to irregularities, silicone grease for heat dissipation, or the like can be adopted.

### (Second Heat Transfer Member)

The second heat transfer member 430 moves the heat of the secondary battery 200 or the heat to the secondary battery 200 to the upper side or from the upper side. Hereinafter, a side of the cooling and heating unit 410 with respect to the secondary battery 200 may be referred to as a lower side, and a side opposite to the cooling and heating unit 410 with respect to the secondary battery 200 may be referred to as an upper side. The secondary battery 200 is fixed by a fixing member (not illustrated), for example, a case or a binding bar, and can be configured such that the heat of the secondary battery 200 is transmitted to the fixing member via the second heat transfer member 430. Thus, since the heat of the secondary battery 200 is dissipated to the upper side in addition to the lower side by the second heat transfer member 430, cooling efficiency of the secondary battery 200 is improved.

Similarly to the first heat transfer member 420, a thermally conductive gel such as a silicone gel may be used for the second heat transfer member 430. For example, as the second heat transfer member 430, a urethane-based, epoxy-based, modified silane-based, or acryl-based heat dissipation adhesive, a silicone putty sheet for heat dissipation that is clayey and closely adheres to irregularities, silicone grease for heat dissipation, or the like can be adopted. In addition, without providing the second heat transfer member 430 on the secondary battery 200, the heat of the secondary battery 200 can be directly dissipated to the fixing member or an upper space of the secondary battery 200.

### (Secondary Battery)

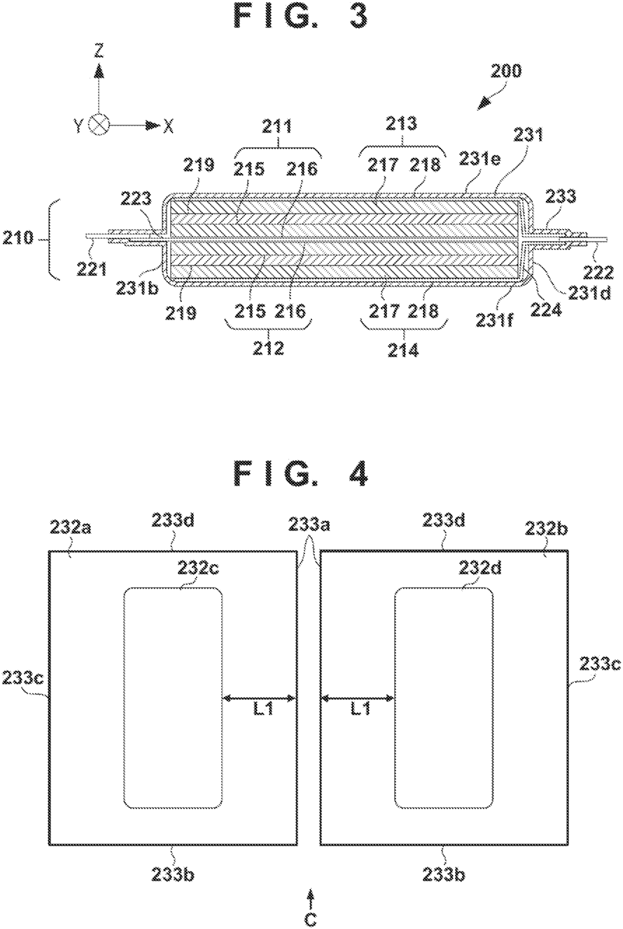

FIG. 2 is a front view of the secondary battery according to one embodiment, and FIG. 3 is a cross-sectional view of the secondary battery according to one embodiment taken along line A-A. In the drawing, an arrow X indicates a longitudinal direction of the secondary battery 200 (or an extending direction of a lead terminal), an arrow Y indicates a width direction of the secondary battery 200 (or a direction orthogonal to the extending direction of the lead terminal), and an arrow Z indicates the thickness direction of the secondary battery 200 (stacking direction of a laminate 210). The X direction, the Y direction, and the Z direction are orthogonal to each other. FIG. 2 is a view of the secondary battery 200 as viewed in the Z direction, and is a view as viewed from the stacking direction of the stacked product of the secondary battery 200 and the separator 300 illustrated in FIG. 1.

The secondary battery 200 includes the laminate 210 that is an element of the secondary battery, lead terminals 221 and 222, current collecting terminals 223 and 224, and an exterior body 230 wrapping the laminate 210, and has a form of a battery cell suitable for an assembled battery.

The laminate 210 has a rectangular parallelepiped shape as a whole, and as illustrated in FIG. 3, includes two positive electrode layers 211 and 212 and two negative electrode layers 213 and 214, and has a structure including the two positive electrode layers and the two negative electrode layers. However, as the laminate 210, the positive electrode layer and the negative electrode layer may be one layer or three or more layers. Electrolyte layers 219 are respectively provided between the positive electrode layer 211 and the negative electrode layer 213 and between the positive electrode layer 212 and the negative electrode layer 214.

The positive electrode layers 211 and 212 each include a positive electrode active material layer 215, and have a positive electrode current collector 216 common to the two positive electrode layers 211 and 212. The positive electrode current collector 216 is disposed in a layered manner at the center of the laminate 210 in the Z direction, and the positive electrode active material layers 215 are stacked on the front and back sides thereof.

The negative electrode layers 213 and 214 are arranged outside in one direction and outside in the other direction in the Z direction with respect to the positive electrode layers 211 and 212, and these layers are stacked such that the negative electrode layers 213 and 214 sandwich the positive electrode layers 211 and 212. However, contrary to the configuration of the present embodiment, it is also possible to adopt a configuration in which those layers are stacked such that the two positive electrode layers sandwich the two negative electrode layers. The negative electrode layers 213 and 214 each include a negative electrode active material layer 217 and a negative electrode current collector 218. The two negative electrode current collectors 218 are each formed in a layered manner on an outermost layer of the laminate 210.

Examples of the active material constituting the positive electrode active material layer 215 include lithium cobalt oxide, lithium nickel oxide, lithium manganese oxide, and lithium metal phosphate. Examples of the active material constituting the negative electrode active material layer 217 include a lithium-based material and a silicon-based material. Examples of the lithium-based material include Li metal and Li alloy. Examples of the silicon-based material include Si and SiO. Other examples of the active material constituting the negative electrode active material layer 217 include carbon materials such as graphite, soft carbon, and hard carbon, tin-based materials (Sn, SnO, and the like), and lithium titanate.

The electrolyte layer 219 includes, for example, a solid, gel, or liquid electrolyte having ion conductivity, and examples of the material include a sulfide-based solid electrolyte material, an oxide-based solid electrolyte material, a nitride-based solid electrolyte material, a halide-based solid electrolyte material, a lithium-containing salt, and a gel material containing a lithium ion conductive ionic liquid. The positive electrode current collector 216 and the negative electrode current collector 218 are formed of, for example, a metal foil, a metal sheet, or a metal plate, such as aluminum, copper, or SUS. The positive electrode active material layer 215, the negative electrode active material layer 217, and the electrolyte layer 219 may be formed by bonding particles of substances constituting these layers with an organic polymer compound-based binder. In one embodiment, the secondary battery 200 may be an all-solid-state battery.

The lead terminals 221 and 222 are connected to a charger or an electric load to charge or discharge the laminate 210. One end portions of the lead terminals 221 and 222 are located outside the exterior body 230, and the other end portions are located inside the exterior body 230. In this case, the inside of the exterior body 230 refers to a space formed by a sealing portion of the exterior body 230 described later.

The other end portion of the lead terminal 221 is connected to the positive electrode current collector 216 via the current collecting terminal 223 inside the exterior body 230, and the lead terminal 221 forms a positive electrode terminal. The lead terminal 221 and the current collecting terminal 223 are formed of, for example, a conductive metal sheet or metal plate. On the other hand, the other end portion of the lead terminal 222 is connected to the negative electrode current collector 218 via the current collecting terminal 224 inside the exterior body 230, and the lead terminal 222 forms a negative electrode terminal. The lead terminal 222 and the current collecting terminal 224 are formed of, for example, a conductive metal sheet or metal plate.

The arrangement of the lead terminals 221 and 222 is not particularly limited, and the lead terminals 221 and 222 may be arranged at both ends in the longitudinal direction (X direction) of the secondary battery 200, or may be arranged at one end (arranged on the upper side) in the width direction (Y direction) of the secondary battery 200. In one embodiment, the lead terminals 221 and 222 are arranged at both ends in the longitudinal direction (X direction) of the secondary battery 200, and in this arrangement, a current flows in the longitudinal direction of the secondary battery 200 during charging and generates heat accordingly. However, since the first heat transfer member 420 and the second heat transfer member 430 are arranged along the longitudinal direction of the secondary battery 200, the cooling efficiency of the secondary battery 200 is improved.

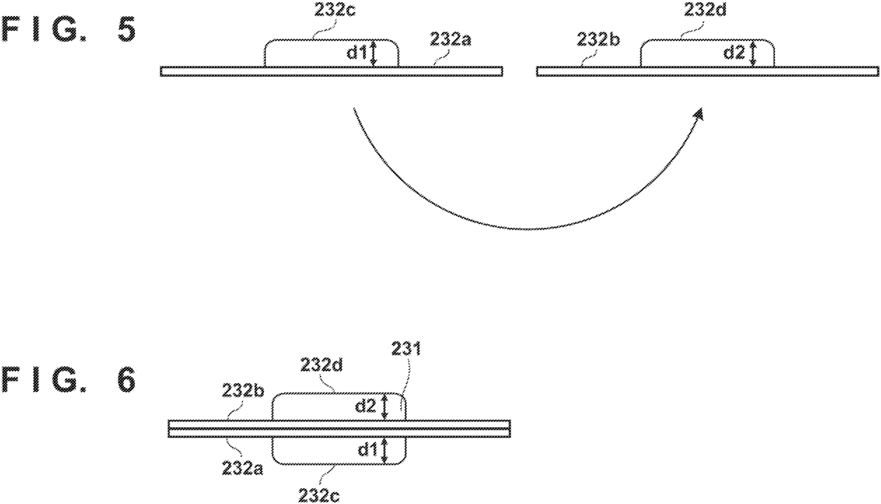

FIG. 4 is a plan view illustrating a configuration of a material for forming the exterior body according to one embodiment, FIG. 5 is a view taken in the direction of arrow C in FIG. 4, and FIG. 6 is a schematic view in which the materials forming the exterior body according to one embodiment are overlapped as indicated by an arrow in FIG. 5.

As illustrated in FIG. 3, the exterior body 230 wraps the laminate 210. In the present embodiment, two materials for forming the exterior body 230 as illustrated in FIG. 4, for example, laminate films 232a and 232b are overlapped as indicated by the arrow illustrated in FIG. 5 to form the exterior body 230 as illustrated in FIG. 6. The laminate films 232a and 232b have recesses 232c and 232d, respectively, and the housing portion 231 is formed by overlapping the laminate films 232a and 232b.

The housing portion 231 includes rectangular principal surfaces 231e and 231f that extend in a plane (XY plane) intersecting a stacking direction (Z direction) of the laminate 210 and face each other, and side surfaces 231a to 231d arranged so as to connect the principal surfaces 231e and 231f (see FIGS. 2 and 3).

The laminate films 232a and 232b are formed by, for example, covering front and back surfaces of a metal layer with a resin layer (insulating layer). The exterior body 230 formed of the laminate films 232a and 232b has flexibility capable of following expansion and contraction of the laminate 210. The flexibility capable of following the expansion and contraction of the laminate 210 can be obtained by the way of wrapping the laminate 210, the shape and structure of the exterior body 230, and the like.

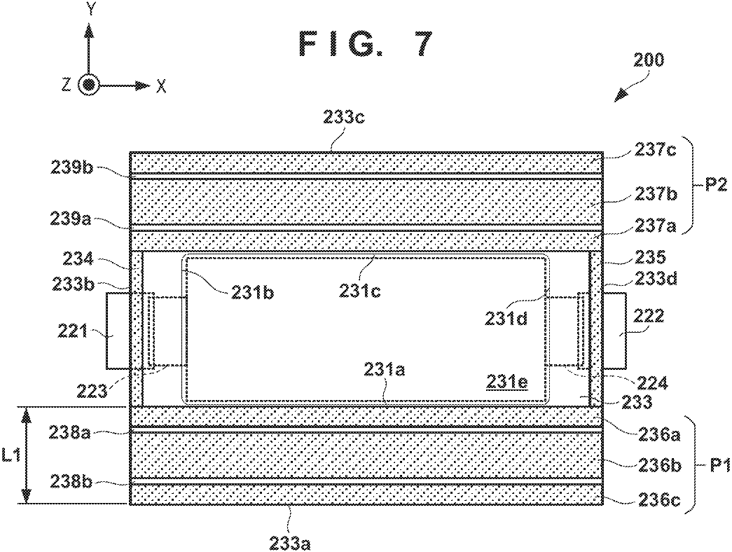

FIG. 7 is a front view of the secondary battery according to one embodiment, and is a view illustrating a state before an upper portion and a lower portion of the exterior body sealed are folded. When viewed in the Z direction, the exterior body 230 includes the housing portion 231 that houses the laminate 210, and a peripheral edge portion 233 around the housing portion 231. The peripheral edge portion 233 has four sides 233a to 233d when viewed in the Z direction. In this embodiment, the housing portion 231 is disposed at a central portion of the exterior body 230 as viewed in the Z direction, but may be arranged biased to the left and right and/or up and down.

The secondary battery is formed by housing the laminate 210 in which the lead terminals 221 and 222 and the current collecting terminals 223 and 224 are connected in the recess 232c of one laminate film 232a, overlapping the other laminate film 232b as illustrated in FIGS. 5 and 6, and bonding the materials to each other by adhesion, welding, or the like so as to include the four sides 233a to 233d of the peripheral edge portion 233 around the housing portion 231 as illustrated in FIG. 7.

In this bonding, the sides 233b and 233d of the peripheral edge portion 233 include sealing portions 234 to 235 bonded to include them. As also illustrated in FIGS. 2 and 3, the peripheral edge portion including the sealing portions 234 to 235 extends from the side surfaces 231b and 231d in a direction (X direction) substantially orthogonal to the side surfaces 231b and 231d of the housing portion 231.

In addition, in this bonding, the peripheral edge portion 233 connected to the side surfaces 231a and 231c of the housing portion 231 has sealing portions 236a to 236c and 237a to 237c discontinuously bonded toward the sides 233a and 233c, respectively. The sealing portions 236a to 236c and 237a to 237c each have a substantially rectangular shape extending in the length direction (X direction) of the secondary battery 200 and the width direction (Y direction) of the secondary battery 200 as viewed in the stacking direction (Z direction) of the laminate 210.

Between the sealing portions, there is a non-sealing portion where the materials are not bonded to each other. A non-sealing portion 238a and a non-sealing portion 238b are located so as to be sandwiched between the sealing portions 236a and 236b and between the sealing portions 236b and 236c, respectively. Similarly, a non-sealing portion 239a and a non-sealing portion 239b are located so as to be sandwiched between the sealing portions 237a and 237b and between the sealing portions 237b and 237c, respectively. Similarly to the sealing portion, the non-sealing portions 238a, 238b, 239a, and 239b also have a substantially rectangular shape extending in the length direction (X direction) of the secondary battery 200 and the width direction (Y direction) of the secondary battery 200.

The sealing portions 236a to 236c and the non-sealing portions 238a and 238b, and the sealing portions 237a to 237c and the non-sealing portions 239a and 239b respectively correspond to folding portions P1 and P2 folded along the housing portion 231. The non-sealing portions 238a, 238b, 239a, and 239b correspond to the bent portions of the folding portions P1 and P2. That is, the folding portions P1 and P2 are connected to two sides of the rectangular shape of the housing portion 231. As described later, the folding portions P1 and P2 extend along the side surfaces 231a and 231c in a direction (Z direction) substantially horizontal to the side surfaces 231a and 231c of the housing portion 231. Thus, in FIG. 2, the upper and lower surfaces of the exterior body 230 are flat.

### (Bent Structure of Exterior Body According to One Embodiment)

As illustrated in FIG. 1, when the secondary battery 200 is used for the battery module 100, the secondary battery 200 is disposed such that a predetermined surface (lower surface) of the secondary battery 200 is in contact with the first heat transfer member 420. In another embodiment, the second heat transfer member 430 is further disposed in contact with another surface (upper surface) of the secondary battery 200. In still another embodiment, the first heat transfer member 420 and the second heat transfer member 430 may be configured as one first heat transfer member 420 and one second heat transfer member 430, respectively, and one first heat transfer member 420 or one second heat transfer member 430 may be configured to be in contact with the plurality of secondary batteries 200. At this time, in order to efficiently move heat of the secondary battery 200 or heat to the secondary battery 200, adhesion between the secondary battery 200 and the first heat transfer member 420 and the second heat transfer member 430 may be improved. Thus, in the present embodiment, a folded structure of the exterior body 230 described below is adopted.

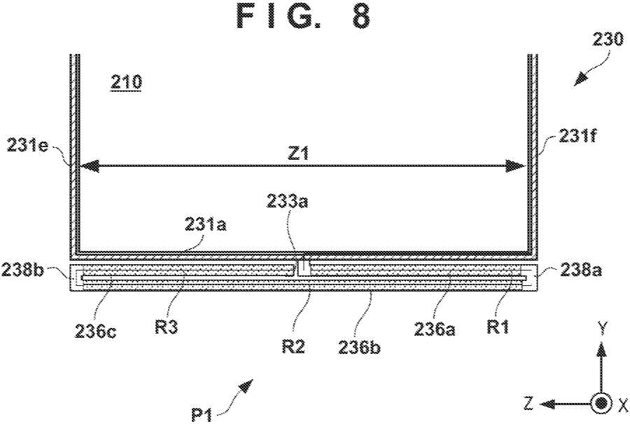

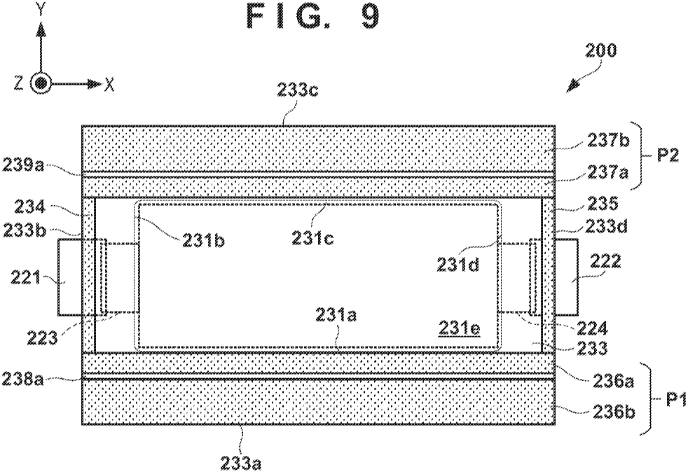

FIG. 8 is a cross-sectional view taken along line B-B in FIG. 2, and is a view illustrating a bent structure of the exterior body according to one embodiment. FIG. 8 is a view illustrating a structure of a lower portion of the secondary battery 200. On the other hand, the structure (including the bent structure) of an upper portion of the secondary battery 200 in the cross-sectional view taken along line B-B in FIG. 2 is equivalent to the structure obtained by inverting FIG. 8, and thus is omitted. In FIG. 8 (and FIGS. 9 and 10 described later), there are portions where the thickness, spacing, and the like of members are emphasized in order to facilitate understanding of the structure.

In the present embodiment, in the peripheral edge portion 233, portions (folding portions P1 and P2) of the peripheral edge portion connected to the side surfaces 231a and 231c of the housing portion 231 are folded along the side surfaces 231a and 231c of the housing portion 231. Since the structure of the upper portion of the secondary battery 200 is omitted as described above, the folding portion P2 is not illustrated in FIG. 8.

The folding portion P1 includes a region R1 extending from a connection portion with the housing portion 231 to one side in the stacking direction (positive side in the Z direction) of the laminate 210 and a region R2 extending from an end portion of the region R1 on the positive side in the Z direction to the other side (negative side in the Z direction) opposite thereto. As described above, the folding portion P1 is folded to form a plurality of the regions R1 and R2, so that the secondary battery 200 and the first heat transfer member 420 easily come into close contact with each other. Thus, since a gap or the like is less likely to be generated between the secondary battery 200 and the first heat transfer member 420, the heat of the secondary battery 200 or the heat to the secondary battery 200 can be efficiently moved to or from the cooling and heating unit 410. Accordingly, the cooling and heating efficiency of the secondary battery 200 is improved.

A sealed portion of the exterior body is hard and is difficult to be folded since the materials of the exterior body are bonded to each other. However, in the present embodiment, the materials are not bonded to each other at the bent portion between the region R1 and the region R2 of the folding portion P1. That is, the bent portion is formed of the bendable non-sealing portion 238a. On the other hand, the region R1 and the region R2 are formed of the sealing portion 236a and the sealing portion 236b, respectively. Hereinafter, the bent portion between the region R1 and the region R2 may be referred to as the bent portion 238a.

The region R2 extends from an end on one side (positive side) to an end on the other side (negative side in the Z direction) in the stacking direction (Z direction) of the laminate 210. Thus, since the region R2 is provided to extend substantially over the entire region in the stacking direction below the laminate 210, a contact surface with the first heat transfer member 420 in the secondary battery 200 can be configured by the region R2. Therefore, the secondary battery 200 and the first heat transfer member 420 easily come into close contact with each other.

The folding portion P1 includes a region R3 extending toward the positive side in the Z direction from an end portion of the region R2 on the negative side in the Z direction to an edge (side 233a) of the peripheral edge portion 233. As a result, the height of the folding portion P1 is stabilized, and the secondary battery 200 and the first heat transfer member 420 easily come into close contact with each other.

The regions R1 and R3 are located on the laminate 210 side relative to the region R2. That is, the region R2 is a region toward which the folding portion P1 is bent downward (on the side far from the laminate 210) at the bent portion 238a at the end portion on the positive side in the Z direction of the region R1. The region R3 is a region toward which the folding portion P1 is folded back to the upper side (laminate 2 side) at the bent portion (non-sealing portion 238b) on the negative side in the Z direction of the region R2. Hereinafter, the bent portion between the region R2 and the region R3 may be referred to as the bent portion 238b. As a result, the folding portion P1 and the heat transfer member 420 come into contact with each other only in the region R2, so that a step or the like is less likely to be formed on a contact surface between them. Thus, the secondary battery 200 and the first heat transfer member 420 easily come into close contact with each other.

In one embodiment, a length L1 (see FIG. 7) from the side surface 231a of the housing portion 231 to the edge (side 233a) of the peripheral edge portion 233 can be approximately twice a length Z1 (see FIG. 8) of the laminate 210 in the stacking direction. In other words, the length L1 is approximately twice the length Z1 of the housing portion 231 in the stacking direction. As a result, a total length of the regions R1 and R3 and the length of the region R2 become substantially the same in the stacking direction (Z direction) of the laminate 210. Thus, since the thickness of the folding portion P1 in the Y direction is made uniform over the entire laminate 210 in the stacking direction (Z direction), the secondary battery 200 and the heat transfer member 420 easily come into close contact with each other. For example, approximately twice may indicate 1.95 to 2.05 times, 1.9 to 2.1 times, 1.8 to 2.2 times, 1.7 to 2.3 times, or the like. That is, a relationship between the total length of the regions R1 and R3 and the length of the region R2 may be any relationship as long as the secondary battery 200 and the first heat transfer member 420 are easily in close contact with each other.

As described in the bent structure of the exterior body according to another embodiment, the length L1 may be longer than the length from the connection portion between the folding portion P1 and the housing portion 231 to any end portion of the housing portion 231 in the Z direction. As a result, since the folding portion P1 can be extended to at least the end portion of the housing portion 231 in the Z direction, it is possible to prevent the folding portion P1 from being interrupted at a position overlapping the side surface 231a in the Z direction and a step from being generated.

Next, the structures of the laminate films 232a and 232b as members forming the exterior body 230 will be described with reference to FIGS. 4 to 6 again. The laminate films 232a and 232b have a sheet-like shape as a whole, and the recesses 232c and 232d are formed, respectively.

The recess 232c is a depression having a depth d1 with respect to the sheet-like portion. The recess 232d is a depression having a depth d2 with respect to the sheet-like portion. Here, although the depth d1 = the depth d2, the depths of the recesses 232c and 232d may be different.

The recess 232c and the recess 232d are provided so that a distance L1 is equal to or more than a sum of the depth d1 and the depth d2. Since the length of the folding portion P1 can be secured to be relatively long, the folding portion P1 is easily folded along the housing portion 231. In addition, when the distance L1 is equal to or more than the sum of the depth d1 and the depth d2, the folding portion P1 can extend from the connection portion between the housing portion 231 and the folding portion P1 in the Z direction to the end portion on the positive side or the negative side in the Z direction of the housing portion 231.

In addition, in the present embodiment, the recess 232c and the recess 232d are arranged such that the distance L1 is approximately four times the sum of the depth d1 and the depth d2. Accordingly, when the exterior body 230 is formed of the laminate films 232a and 232b, the folding portion P1 can be folded to form the regions R1 to R3.

In the peripheral edge portion 233, a portion (folding portion P2) of the peripheral edge portion connected to the side surface 231c of the housing portion 231 also has a bent structure similar to the folding portion P1. As a result, as illustrated in FIG. 1, when the secondary battery 200 is used for the battery module 100, the secondary battery 200 and the second heat transfer member 430 easily come into close contact with each other. Thus, since a gap or the like is less likely to be generated between the secondary battery 200 and the second heat transfer member 430, the heat of the secondary battery 200 or the heat to the secondary battery 200 can be efficiently moved to or from the upper side. Thus, the cooling and heating efficiency of the secondary battery 200 is improved.

When the peripheral edge portion 233 is provided with the folding portions P1 and P2 and is not folded, it is necessary to make the first heat transfer member 420 and the second heat transfer member 430 thick in the Y direction in order to absorb irregularities of the peripheral edge portion 233. In the present embodiment, since the contact surface between the folding portions P1 and P2 and the first heat transfer member 420 and the contact surface with the second heat transfer member 430 are flat due to the folding portions P1 and P2, the first heat transfer member 420 and the second heat transfer member 430 can be thinned in the Y direction. The laminate 210 can be made larger in the Y direction in the secondary battery 200 having the same size as the first heat transfer member 420 and the second heat transfer member 430 are thinned, which can also contribute to improvement of the energy density of the battery module 100.

When the secondary battery 200 is used for the battery module 100, the folding portions P1 and P2 are in contact with the first heat transfer member 420 and the second heat transfer member 430, and therefore, the side surfaces 231a and 231c of the housing portion 231 are not in direct contact with the first heat transfer member 420 and the second heat transfer member 430. When the side surfaces 231a and 231c of the housing portion 231 are in contact with the first heat transfer member 420 and the second heat transfer member 430, the side surfaces 231a and 231c also expand and contract following the expansion and contraction of the laminate 210. When the gel-like first heat transfer member 420 and second heat transfer member 430 are bonded to the side surfaces 231a and 231c in consideration of heat transfer properties, the thicknesses of the first heat transfer member 420 and the second heat transfer member 430 may be secured such that the gel-like first heat transfer member 420 and second heat transfer member 430 extend in accordance with the expansion of the side surfaces 231a and 231c.

In the present embodiment, since the folding portions P1 and P2 that do not follow the expansion and contraction of the laminate 210 come into contact with the first heat transfer member 420 and the second heat transfer member 430, there is no need to consider the extension of the gel-like first heat transfer member 420 and second heat transfer member 430. Also from this viewpoint, in the present embodiment, the first heat transfer member 420 and the second heat transfer member 430 can be thinned in the Y direction.

### (Bent Structure of Exterior Body According to Another Embodiment)

FIG. 9 is a front view of a secondary battery according to another embodiment, and is a view illustrating a state before an upper portion and a lower portion of a sealed exterior body are folded. FIG. 10 is a view illustrating a bent structure of the exterior body according to another embodiment. Hereinafter, the description of the same configuration as the bent structure of the exterior body according to one embodiment will be omitted. Since the structure (including the bent structure) of an upper portion of a secondary battery 200 is equivalent to the structure obtained by inverting FIG. 10, the structure is omitted in FIG. 10 as in FIG. 8.

FIG. 9 illustrates a state before an exterior body 230 illustrated in FIG. 10 is folded. The exterior body 230 illustrated in FIG. 10 is different from the bent structure of the exterior body 230 of one embodiment mainly in that a folding portion P1 does not include a region R3. That is, the folding portion P1 is bent at two points of a connection portion with a housing portion 231 and a bent portion 238a between a region R1 and a region R2. Even with such a configuration, a heat transfer member 420 of the secondary battery 200 and the folding portion P1 easily come into close contact with each other. The region R1 and the region R2 are formed by the sealing portion 236a and the sealing portion 236b, respectively, and the bent portion between the region R1 and the region R2 is formed by the non-sealing portion 238a.

### (Bent Structure of Exterior Body According to Still Another Embodiment)

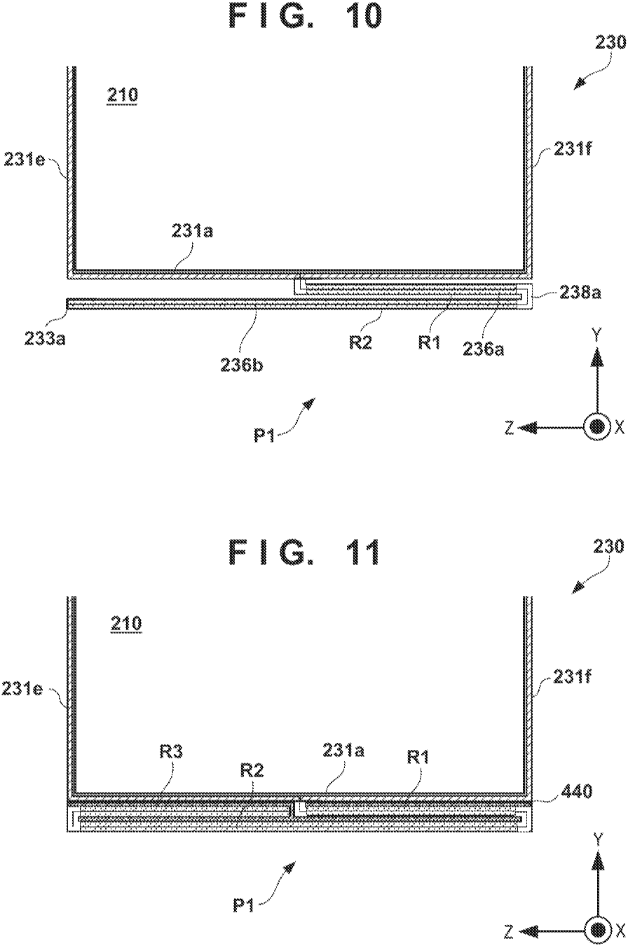

FIG. 11 is a view illustrating a bent structure of an exterior body according to still another embodiment. Hereinafter, the description of the same configuration as the bent structure of the exterior body according to one embodiment will be omitted. Since the structure (including the bent structure) of an upper portion of a secondary battery 200 is equivalent to the structure obtained by inverting FIG. 11, the structure is omitted in FIG. 11 as in FIG. 8.

The exterior body 230 illustrated in FIG. 11 is different from the bent structure of the exterior body 230 of one embodiment mainly in that a highly viscous fluid 440 is applied to a folding portion P1. For example, in the secondary battery 200, in a state before the folding portion P1 is folded (see FIG. 7), the folding portion P1 is folded in a state where the highly viscous fluid 440 is applied to the folding portion P1. Alternatively, the highly viscous fluid 440 may be introduced into the folding portion P1 in a state where the folding portion P1 is folded.

The highly viscous fluid 440 is provided between the side surface 231a of the exterior body 230 and the regions R1 and R3, and between the regions R1 and R3 and the region R2. The highly viscous fluid 440 may also be provided between the region R2 and the first heat transfer member 420. However, the arrangement of the highly viscous fluid 440 can be appropriately changed. For example, since it is difficult to form an air layer between the region R2 and the first heat transfer member 420, a highly viscous fluid may not be provided between the region R2 and the first heat transfer member 420, and the region R2 and the first heat transfer member 420 may be in direct contact with each other.

In the secondary battery 200 of one embodiment, although the folded laminate films (for example, the region R1 and the region R2) of the folding portion P1 are in contact with each other, strictly, an air layer exists therebetween. However, in the bent structure of the exterior body according to still another embodiment, since the highly viscous fluid 440 is applied to a gap of the folding portion P1, the adhesion between the laminate films is improved. Thus, heat can be more effectively transferred from the secondary battery 200 to the first heat transfer member 420. In addition, the highly viscous fluid 440 may be a thin film. As a result, thermal resistance is lowered, and the heat transfer properties are further improved.

As the highly viscous fluid 440, grease having thermal conductivity can be used, and examples of the grease include mineral oil and silicone blended with a thermally conductive filler. As the highly viscous fluid, for example, one having ASTM (JIS) consistency of 1 to 6 can be used from the viewpoint of reducing pump out.

### (Combination of Bent Structure of Exterior Body)

The bent structure of the exterior body may be the same bent structure at the lower folding portion P1 and the upper folding portion P2 of the secondary battery 200, or may be different bent structures. For example, both the lower folding portion P1 and the upper folding portion P2 of the secondary battery 200 may have the bent structure illustrated in FIG. 8, or while the lower folding portion P1 of the secondary battery 200 may have the bent structure illustrated in FIG. 8, the upper folding portion P2 of the secondary battery 200 may have the bent structure illustrated in FIG. 9.

### Secondary Battery According to Another Embodiment

A secondary battery according to another embodiment includes a laminate in which a positive electrode layer, an electrolyte layer, and a negative electrode layer are stacked, and an exterior body wrapping the laminate, in which the exterior body is formed by folding back one material for forming the exterior body at a folding back portion, and includes a housing portion which includes the folding back portion as a part thereof, and houses the laminate, and a peripheral edge portion around the housing portion. In addition, the peripheral edge portion includes a folding portion folded along the housing portion, the materials are not bonded to each other on a bent portion where the folding portion is bent, and the materials are bonded to each other at portions other than the bent portion. As a result, the cooling efficiency of a battery can be improved.

The secondary battery according to another embodiment is different from the secondary battery 200 according to one embodiment in that the exterior body is formed by folding back one material at the folding back portion. Hereinafter, the exterior body different from the secondary battery 200 according to one embodiment will be mainly described. In the secondary battery according to another embodiment, the same configuration as that of the secondary battery according to one embodiment is given a reference sign that is one digit higher. For example, in one embodiment, the secondary battery is denoted as the secondary battery 200, and in another embodiment, the secondary battery is denoted as a secondary battery 2000.

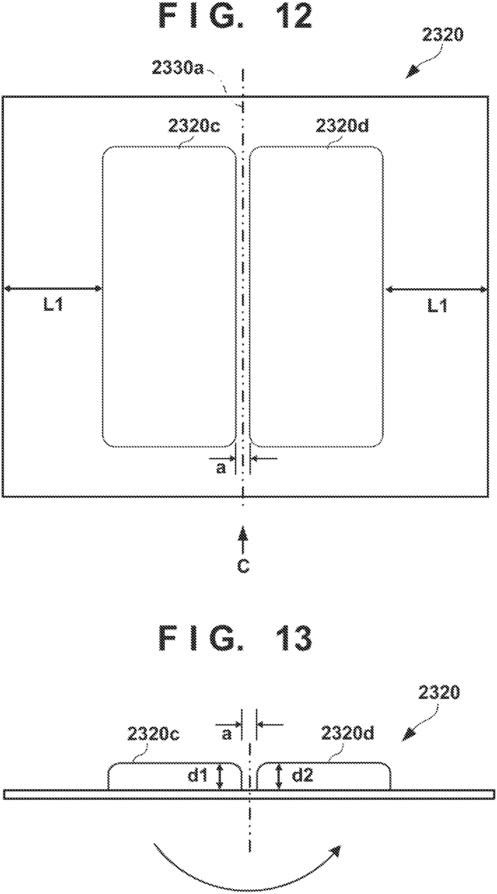

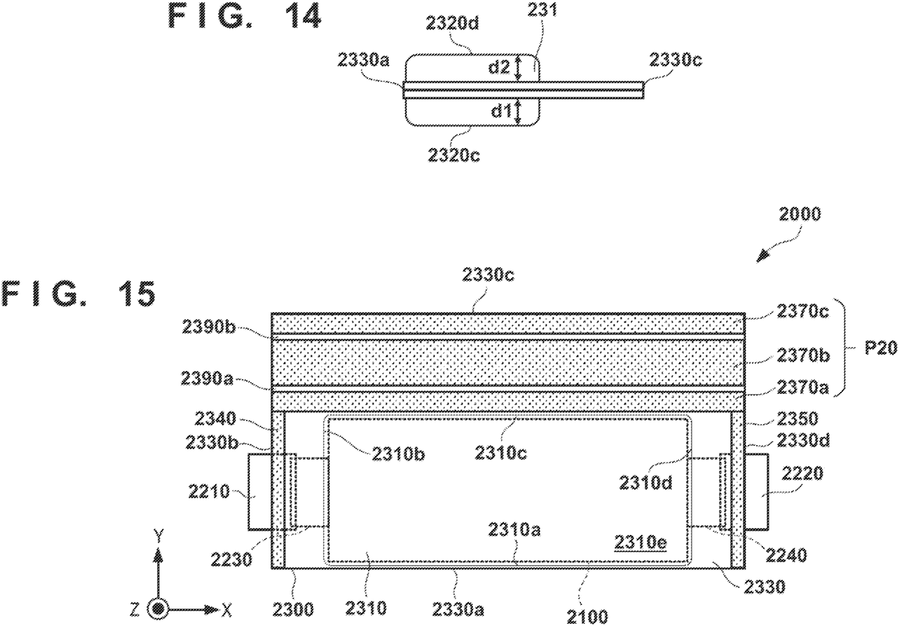

FIG. 12 is a plan view illustrating a configuration of a material for forming the exterior body according to another embodiment, FIG. 13 is a view taken in the direction of arrow C in FIG. 12, and FIG. 14 is a view in which the material for forming the exterior body according to one embodiment is folded and overlaid as indicated by an arrow in FIG. 13. FIG. 15 is a front view of the secondary battery according to another embodiment, and is a view illustrating a state before the upper portion of the sealed exterior body is folded. That is, FIG. 15 is a view in which a peripheral edge portion 2330 of the folded and overlaid material illustrated in FIG. 14 is sealed.

The exterior body 2300 wraps a laminate 2100. In the present embodiment, the exterior body 2300 is formed by folding a material for forming the exterior body 2300, for example, a laminate film 2320 in two at a folding back portion a. As the laminate film 2320, a material similar to that of the laminate film 232 according to one embodiment can be adopted, and has flexibility capable of following expansion and contraction of the laminate 2100.

In another embodiment, the exterior body 2300 includes a housing portion 2310 which is located in a lower central portion when viewed in the Z direction and houses the laminate 2100, and the peripheral edge portion 2330 around the housing portion 2310. The peripheral edge portion 2330 has four sides 2330a to 2330d when viewed in the Z direction (see FIG. 15).

As illustrated in FIGS. 12 to 14, recesses 2320c and 2320d formed on both sides of the folding back portion a of the laminate film 2320 are overlapped to form the housing portion 2310. The housing portion 2310 includes principal surfaces 2310e and 2310f that extend in a plane (XY plane) intersecting the stacking direction (Z direction) of the laminate 2100 and face each other, and side surfaces 2310a to 2310d arranged so as to connect the principal surfaces 2310e and 2310f.

The peripheral edge portion 2330 is formed by overlapping portions where the recesses 2320c and 2320d are not formed in the state where the laminate film 2320 is opened. In another embodiment, the side 2330a of the four outer sides of the peripheral edge portion 2330 is included in the folding back portion a formed when the laminate film 2320 is folded back, and one site (side surface 2310a) of the housing portion 2310 includes a part of the folding back a therealong.

In FIGS. 12 and 14, in order to facilitate understanding of the folding back portion a, although the side surface 2310a of the housing portion 2310 including the folding back portion a is shown to be wide, the side surface 2310a is flat as illustrated in FIG. 1. In other words, among the side surfaces of the housing portion 2310, the peripheral edge portion 2330 extends from the side surfaces 2310b and 2310d in a substantially normal direction of the surface, whereas with respect to the side surface 2310a, the side 2330a of the peripheral edge portion 2330 does not substantially extend.

As illustrated in FIG. 15, the secondary battery is formed by housing the laminate 2100 in which the lead terminals 2210 and 2220 and the current collecting terminals 2230 and 2240 are connected in the recess 2320c of the laminate film 2320, folding back the laminate film 2320 having the recess 2320c at the folding back portion a as illustrated in FIGS. 13 and 14, and bonding the materials to each other by adhesion, welding, or the like so as to include the three sides 2330b to 2330d of the peripheral edge portion 2330.

In this bonding, the sides 2330b and 2330d of the peripheral edge portion 2330 include sealing portions 2340 to 2350 bonded to include them. In addition, in this bonding, the peripheral edge portion 2330 connected to the side surface 2310c of the housing portion 2310 has sealing portions 2370a to 2370c discontinuously bonded toward the side 2330c. The sealing portions 2370a to 2370c each have a substantially rectangular shape extending in the length direction (X direction) of the secondary battery 2000 and the width direction (Y direction) of the secondary battery 200 as viewed in the stacking direction (Z direction) of the laminate 210.

Between the sealing portions, there is a non-sealing portion where the materials are not bonded to each other. A non-sealing portion 2390a and a non-sealing portion 2390b are located so as to be sandwiched between the sealing portions 2370a and 2370b and between the sealing portions 2370b and 2370c, respectively.

The sealing portions 2370a to 2370c and the non-sealing portions 2390a and 2390b correspond to a folding portion P20 folded along the housing portion 2310. The non-sealing portions 2390a and 2390b correspond to the bent portions of the folding portion P20. That is, the folding portion P20 is connected to one side of the rectangular shape of the housing portion 2310. As described later, the folding portion P20 extends along the side surface 2310c in a direction (Z direction) substantially horizontal to the side surface 2310c of the housing portion 2310.

In FIG. 15, the folding portion P20 is provided in an upper portion of the secondary battery 2000, and the side surface 2310a of the housing portion 2310 including the folding back portion a is flat in a lower portion of the secondary battery 2000; however, a folding portion P10 may be provided in the lower portion of the secondary battery 2000, and the side surface 2310c of the housing portion 2310 including the folding back portion a may be flat in the upper portion of the secondary battery 2000.

The secondary battery 2000 according to another embodiment has the same configuration and structure as those of the laminate 210 according to one embodiment illustrated in FIG. 3. In addition, the secondary battery 2000 according to another embodiment can be replaced with the secondary battery 200 of the battery module 100 according to one embodiment illustrated in FIG. 1, and can constitute a battery module 1000. However, as described above, the secondary battery 2000 according to another embodiment has a configuration in which an upper side or a lower side thereof is flat and the other side includes a folding portion. That is, the first heat transfer member or the second heat transfer member comes into contact with the folding portion. In addition, in the exterior body 2300 of the secondary battery 2000 according to another embodiment, the bent structure of the exterior body 230 according to one embodiment described with reference to FIGS. 8 to 13 can be adopted for the folding portion.

### Summary of Embodiment

The above embodiment discloses at least the following secondary battery and battery module.

1. A secondary battery (2000) according to the above embodiment comprises:
a laminate (2100) in which a positive electrode layer (2110, 2120), an electrolyte layer (2190), and a negative electrode layer (2130, 2140) are stacked; and
an exterior body (2300) wrapping the laminate (2100),
wherein the exterior body (2300) is formed by folding back one material (2320) for forming the exterior body (2300) at a folding back portion (a),
the exterior body (2300) includes a housing portion (2310) which includes the folding back portion (a) as a part thereof, and houses the laminate (2100), and a peripheral edge portion (2330) around the housing portion (2310),
the peripheral edge portion (2330) includes a folding portion (P10, P20) folded along the housing portion (2310), and
in the folding portion (P10, P20), the materials (2320) are not bonded to each other on a bent portion (2380a, 2380b, 2390a, 2390b), and the materials (2320) are bonded to each other at portions other than the bent portion (2380a, 2380b, 2390a, 2390b).

According to this embodiment, since a folding portion in which the peripheral edge portion is folded along the housing portion is provided, the exterior body tends to be flat at the folded portion. Thus, when this portion comes into contact with the heat transfer member, the portion can come into contact with the heat transfer member with good adhesion. Therefore, the secondary battery can be efficiently cooled or heated. Since the exterior body is formed by folding back one material at the folding back portion, a sealed portion is reduced.

2. The secondary battery (200) according to the above embodiment comprises:
a laminate (210) in which a positive electrode layer (211, 212), an electrolyte layer (219), and a negative electrode layer (213, 214) are stacked; and
an exterior body (230) wrapping the laminate (210),
wherein the exterior body (230) is formed by overlapping two materials (232a, 232b) for forming the exterior body (230), and includes a housing portion (231) which houses the laminate (210), and a peripheral edge portion (233) around the housing portion (231),
the peripheral edge portion (233) includes a folding portion (P1, P2) folded along the housing portion (231),
in the folding portion (P1, P2), the materials (232a, 232b) are not bonded to each other on a bent portion (238a, 238b, 239a, 239b), and the materials (232a, 232b) are bonded to each other at portions other than the bent portion (238a, 238b, 239a, 239b).

According to this embodiment, since a folding portion in which the peripheral edge portion is folded along the housing portion is provided, the exterior body tends to be flat at the folded portion. Thus, when this portion comes into contact with the heat transfer member, the portion can come into contact with the heat transfer member with good adhesion. Therefore, the secondary battery can be efficiently cooled or heated. Since the exterior body is formed by overlapping two materials, the exterior body can be easily formed.

3. In the above embodiment,
the housing portion (2310) has a rectangular shape when viewed from a stacking direction of the laminate (2100), and
the folding portion (P10, P20) is connected to one side of the rectangular shape of the housing portion (2310).

According to this embodiment, the upper side and the lower side of the secondary battery can be efficiently cooled or heated. That is, a heat movement path (cross-sectional area of heat movement) from the secondary battery or a heat movement path (cross-sectional area of heat movement) to the secondary battery increases, and the secondary battery can be efficiently cooled or heated.

4. In the above embodiment,
the housing portion (231) has a rectangular shape when viewed from a stacking direction of the laminate (210), and
the folding portion (P1, P2) is connected to two sides of the rectangular shape of the housing portion (231).

According to this embodiment, the upper side and the lower side of the secondary battery can be efficiently cooled or heated. That is, as compared with a case where the folding portions are not provided on the upper side and the lower side of the secondary battery, the heat movement path (cross-sectional area of heat movement) from the secondary battery or the heat movement path (cross-sectional area of heat movement) to the secondary battery increases, and the secondary battery can be efficiently cooled or heated.

5. In the above embodiment,
the folding portion (P1, P2, P10, P20) includes
a first region (R1) extending from a connection portion with the housing portion (231, 2310) to one side in a stacking direction of the laminate (210, 2100), and
a second region (R2) extending from an end on the one side of the first region (R1) to the other side opposite to the one side.

According to this embodiment, the folding portion is folded to form a plurality of regions, so that unevenness of a contact surface between the secondary battery and the heat transfer member is easily reduced. Thus, a gap or the like is less likely to be generated between the secondary battery and the heat transfer member, and the secondary battery and the heat transfer member are more likely to come into close contact with each other, so that the secondary battery can be efficiently cooled.

6. In the above embodiment,
the folding portion (P1, P2, P10, P20) includes a third region (R3) extending to the one side from an end on the other side of the second region (R2) to an edge of the peripheral edge portion (233, 2330).

According to this embodiment, the height of the folding portion is stabilized, and the adhesion between the secondary battery and the heat transfer member can be improved.

7. In the above embodiment,
the first region (R1) and the third region (R3) are located on the laminate (210, 2100) side relative to the second region (R2).

According to this embodiment, the folding portion and the heat transfer member come into contact with each other in the second region, so that a step or the like is less likely to be formed on a contact surface between them. Thus, the adhesion between the secondary battery and the heat transfer member can be improved.

8. In the above embodiment,
the second region (R2) extends from a position of an end on the one side to a position of an end on the other side of the laminate (210, 2100) in the stacking direction.

According to this embodiment, since the second region is provided to extend substantially over the entire region in the stacking direction above or below the laminate, a contact surface with the heat transfer member in the secondary battery can be configured by the second region. Thus, the adhesion between the secondary battery and the heat transfer member can be improved.

9. In the above embodiment,
a length from a connection portion between the folding portion (P1, P2, P10, P20) and the housing portion (231, 2310) to an edge portion of the folding portion (P1, P2, P10, P20) is substantially twice a length in a stacking direction of the laminate (210, 2100).

According to this embodiment, a total length of the first region and the third region and a total length of the second region are substantially the same in the stacking direction of the laminate. Thus, the adhesion between the secondary battery and the heat transfer member can be improved.

10. In the above embodiment,
a highly viscous fluid (440) is applied to the folding portion (P1, P2, P10, P20).

According to this embodiment, it is possible to suppress formation of an air layer between members when the folding portion is folded, and to improve the heat transfer properties.

11. A battery module (100) according to the above embodiment comprises:
the secondary battery according to any one of the above 1-10; and
battery a cooling and heating unit (410) configured to cool or heat the secondary

According to this embodiment, a battery module in which a secondary battery is efficiently cooled or heated is provided.

12. The battery module (100) according to the above embodiment further comprises:
a first heat transfer member (420) disposed between the secondary battery (200, 2000) and the cooling and heating unit (410); and
a second heat transfer member (430) disposed on an opposite side of the first heat transfer member (420) with the secondary battery (200, 2000) interposed therebetween,
the second heat transfer member (430) is in contact with the folding portion (P2, P20).

According to this embodiment, a battery module in which a secondary battery is efficiently cooled or heated is provided.

13. A battery module (100) according to the above embodiment comprises:
the secondary battery (200) according to the above 2 or 4; and
a cooling and heating unit (410) configured to cool or heat the secondary battery (200).

According to this embodiment, a battery module in which a secondary battery is efficiently cooled or heated is provided.

14. The battery module (100) according to the above embodiment further comprises:
a first heat transfer member (420) disposed between the secondary battery (200) and the cooling and heating unit (410); and
a second heat transfer member (430) disposed on an opposite side of the first heat transfer member (420) with the secondary battery (200) interposed therebetween,
the first heat transfer member (420) and the second heat transfer member (430) are in contact with the folding portion (P1, P2).

According to this embodiment, a battery module in which a secondary battery is efficiently cooled or heated is provided.

The invention is not limited to the foregoing embodiments, and various variations/changes are possible within the spirit of the invention.

What is claimed is:

1. A secondary battery comprising:
a laminate in which a positive electrode layer, an electrolyte layer, and a negative electrode layer are stacked: and
an exterior body wrapping the laminate,
wherein the exterior body is formed by folding back one material for forming the exterior body at a folding back portion,
the exterior body includes a housing portion which includes the folding back portion as a part thereof, and houses the laminate, and a peripheral edge portion around the housing portion,
the peripheral edge portion includes a folding portion folded along the housing portion, and
in the folding portion, the materials are not bonded to each other on a bent portion, and the materials are bonded to each other at portions other than the bent portion.

2. A secondary battery comprising:
a laminate in which a positive electrode layer, an electrolyte layer, and a negative electrode layer are stacked; and
an exterior body wrapping the laminate,
wherein the exterior body is formed by overlapping two materials for forming the exterior body, and includes a housing portion which houses the laminate, and a peripheral edge portion around the housing portion,
the peripheral edge portion includes a folding portion folded along the housing portion,
in the folding portion, the materials are not bonded to each other on a bent portion, and the materials are bonded to each other at portions other than the bent portion.

3. The secondary battery according to claim 1,
wherein the housing portion has a rectangular shape when viewed from a stacking direction of the laminate, and
the folding portion is connected to one side of the rectangular shape of the housing portion.

4. The secondary battery according to claim 2,
wherein the housing portion has a rectangular shape when viewed from a stacking direction of the laminate, and
the folding portion is connected to two sides of the rectangular shape of the housing portion.

5. The secondary battery according to claim 1,
wherein the folding portion includes
a first region extending from a connection portion with the housing portion to one side in a stacking direction of the laminate, and
a second region extending from an end on the one side of the first region to the other side opposite to the one side.

6. The secondary battery according to claim 5, wherein the folding portion includes a third region extending to the one side from an end on the other side of the second region to an edge of the peripheral edge portion.

7. The secondary battery according to claim 6, wherein the first region and the third region are located on the laminate side relative to the second region.

8. The secondary battery according to claim 5, wherein the second region extends from a position of an end on the one side to a position of an end on the other side of the laminate in the stacking direction.

9. The secondary battery according to claim 1, wherein a length from a connection portion between the folding portion and the housing portion to an edge portion of the folding portion is substantially twice a length in a stacking direction of the laminate.

10. The secondary battery according to claim 1, wherein a highly viscous fluid is applied to the folding portion.

11. A battery module comprising:
the secondary battery according to claim 1; and
a cooling and heating unit configured to cool or heat the secondary battery.

12. The battery module according to claim 11, further comprising:
a first heat transfer member disposed between the secondary battery and the cooling and heating unit; and
a second heat transfer member disposed on an opposite side of the first heat transfer member with the secondary battery interposed therebetween,
wherein the second heat transfer member is in contact with the folding portion.

13. A battery module comprising:
the secondary battery according to claim 2; and
a cooling and heating unit configured to cool or heat the secondary battery.

14. The battery module according to claim 13, further comprising:
a first heat transfer member disposed between the secondary battery and the cooling and heating unit; and
a second heat transfer member disposed on an opposite side of the first heat transfer member with the secondary battery interposed therebetween,
wherein the first heat transfer member and the second heat transfer member are in contact with the folding portion.
